(19) United States
(12) Patent Application Publication
(10) Pub. No.: US 2025/0286393 A1
(43) Pub. Date: Sep. 11, 2025

(54) CHARGER WITH INTEGRATED ENGINE START FUNCTION

(71) Applicant: NEW FOCUS LIGHTING & POWER TECHNOLOGY (SHANGHAI) cO., LTD., Shanghai (CN)

(72) Inventors: Shiquan GONG, Shanghai (CN); Ming SHAO, Shanghai (CN); Fei TONG, Shanghai (CN)

(21) Appl. No.: 18/620,120

(22) Filed: Mar. 28, 2024

(30) Foreign Application Priority Data
Mar. 8, 2024 (CN) 202420452071.4

(51) Int. Cl. H02J 7/00

(52) U.S. Cl. CPC H02J 7/0034; H02J 7/00304; H02J 7/00308

(57) ABSTRACT

A charger with integrated engine start function, which is connected between an input terminal group and an output terminal group, comprising: a high-frequency charger, an input terminal of the high-frequency charger is connected to the input terminal group, an energy storage module, a first switch controllably connected to the high-frequency charger and the output terminal group, a second switch controllably connected to the high-frequency charger and the energy storage module, a third switch controllably connected to the energy storage module and the output terminal group; a controller connected to the first switch, the second switch and the third switch respectively. Through the combination of the high-frequency charger and the energy storage module, it can provide continuous and stable charging current for the battery, with high charging efficiency, and when the external battery fails, the energy storage module can provide a strong instantaneous current sufficient to start the engine.

### BACKGROUND OF THE INVENTION

### Field of the Invention

The present invention relates to the technical field of charger, particularly to a charger with integrated engine start function.

### Description of the Related Art

Among the mainstream charger products currently sold on the market, chargers with integrated engine start function can be divided into two categories: one is power frequency charger and the other is high-frequency charger. Although these two types of chargers dominate the market, they have exposed many limitations and problems in the actual application process, failing to meet the needs of consumers, and even leading to safety hazards in some extreme cases, seriously affecting the user experience.

There are generally two technical implementations of the charger's integrated engine start function. One is through the combination of a small high-frequency charger and a large power-frequency transformer. This design is for example a hybrid battery charger disclosed in the prior application CN104798282A. High-frequency chargers are mainly designed to meet energy efficiency regulations, because of their high efficiency, they are easy to pass energy efficiency tests such as the CEC (California Energy Commission) or DOE (Department of Energy) in the United States, but due to their small current output (usually no more than 30 A, the lowest is only a few amperes), consumers still need to rely on large power frequency transformers for charging and equipment start-up in actual use. However, the main problems of this approach are:
1) Unstable current: the current is large at the initial stage of charging, and then gradually decreases, resulting in an increase in the actual charging time, and the consumer cannot continue to obtain the nominal maximum current, which is misleading to the consumer.
2) Low charging efficiency: the efficiency of high-frequency chargers can reach more than 72% at maximum current, while the efficiency of power-frequency transformers is only about 60% when charging at high current, resulting in a lot of heat loss and energy waste.
3) Start-up challenges: due to the low efficiency of the power frequency transformer and the limited input power, the nominal maximum current (e.g., 300 A) of the wheel charger on the market has a false marking level. In the actual calculation, it is assumed that the input power supply is 120V AC and the allowable maximum current is 15 A, so the input power is 120V*15 A=1800 W. Considering that the conversion efficiency of the power frequency transformer during the start-up process is about 0.55, the actually maximum power output is 1800 W*0.55=990 W. If the output voltage is reduced to a minimum effective voltage of 7.2 volts, the maximum effective starting current that the output can provide is ideally only 990 W/7.2V=137.5 A, which is far from sufficient to support the engine starting needs of the device in the event of a complete battery failure.

In addition, due to the low charging efficiency of the power frequency transformer, a large amount of heat will be generated during the start-up process, and it is difficult to achieve continuous start-up, and frequent start-up may lead to over-temperature protection or damage to the transformer.

The other implementation consists of just a large power-frequency transformer, which is suitable for markets where there are no efficiency requirements. As shown in FIG. 1, due to the use of linear battery charger circuit 200, this kind of product also has problems such as unstable current, low charging efficiency and limited starting current, and at the same time, due to its large size and weight, it is inconvenient to carry, and must rely on AC power to start, and the heat generation is large, and these problems together constitute the user's bad use experience.

In conclusion, the existing power frequency charger and high-frequency charger generally have the following defects in the design with engine starting function: the charging current cannot be continuously stabilized, the charging efficiency is low, the starting current is small, the equipment is bulky and not easy to carry, the AC power supply must be connected to start, the heat generation is large in the process of use, and these factors greatly restrict the performance and user experience of the product.

### SUMMARY OF THE INVENTION

In order to solve the above technical issues, the invention provides a charger with integrated engine start function.

The technical issue solved by the invention can be achieved by the follows:
a charger with integrated engine start function, which is connected between an input terminal group and an output terminal group, comprising:
a high-frequency charger, an input end of the high-frequency charger being connected to the input terminal group,
an energy storage module,
a first switch, controllably connected to a first output end of the high-frequency charger and a first output terminal of the output terminal group;
a second switch, controllably connected to a second output end of the high-frequency charger and an input end of the energy storage module;
a third switch, controllably connected to an output end of the energy storage module and a first output terminal of the output terminal group;
a controller, a first output end of the controller being connected to the first switch, a second output end of the controller being connected to the second switch, and a third output end of the controller being connected to the third switch.

Preferably, further comprising:
a reverse polarization protection sensor, connected between a first output end of the high-frequency charger and a first input end of the controller.

Preferably, further comprising:
a first current sensor, connected between the high-frequency charger and a second output terminal of the output terminal group;
a second input end of the controller, connected to the first current sensor.

Preferably, further comprising:
a second current sensor, connected between the energy storage module and a second output terminal of the output terminal group;
a third input end of the controller, connected to the second current sensor.

Preferably, further comprising:
a voltage sensor, connected between a fourth input end of the controller and the first output terminal of the output terminal group.

Preferably, further comprising: a display and a button, electrically connected to the controller.

Preferably, the energy storage module is one selected from the group comprising a supercapacitor module, a lithium battery, a lead-acid battery, and a combination thereof.

Preferably, when the first switch is closed, the high-frequency charger provides the output terminal group with a charging current or a starting current; and/or
when the second switch is closed, the high-frequency charger provides the energy storage module with the charging current; and/or
when the third switch is closed, the energy storage module provides the output terminal group with the starting current.

The advantages or benefit effects of the technical solution of the invention is:

Through the combination of the high-frequency charger and the energy storage module, the invention can provide continuous and stable charging current for the battery, with high charging efficiency, and when the external battery fails, the energy storage module can provide a strong instantaneous current sufficient to start the engine, in the absence of AC power, it can still start the engine, which greatly improves the performance and user experience of the product. At the same time, the product has less heat generation during use, and its volume and weight are also small, which is easy to carry.

### BRIEF DESCRIPTION OF THE DRAWINGS

FIG. 1 is a structure diagram of a power frequency charger with integrated engine start function in the prior art;

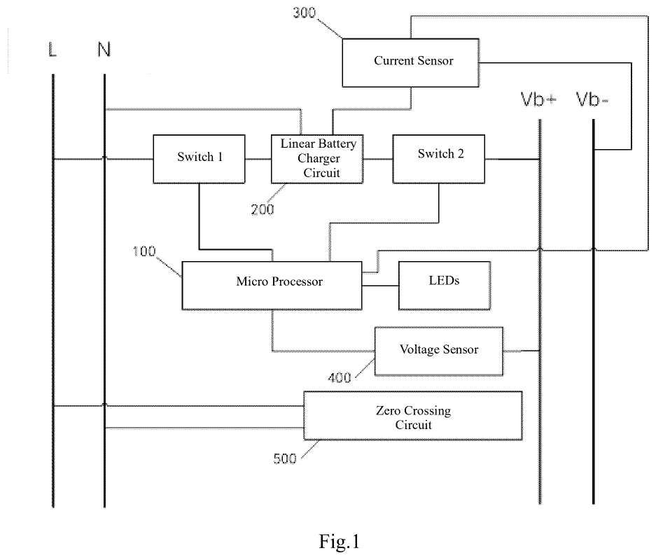

FIG. 2 is a structure diagram of the charger with integrated engine start function in a preferred embodiment of the invention;

FIG. 3 is a structure diagram in which the energy storage module adopts a supercapacitor module in a preferred embodiment of the invention;

FIG. 4 is a structure diagram in which the energy storage module adopts a lithium battery in a preferred embodiment of the invention;

FIG. 5 is a structure diagram in which the energy storage module adopts the lead-acid battery in a preferred embodiment of the invention.

### DETAILED DESCRIPTION

The technical solutions in the embodiments of the present invention will be clearly and completely described below in conjunction with the accompanying drawings in the embodiments of the present invention, and it is clear that the described embodiments are only some embodiments of the present invention, not all embodiments. Based on the embodiments in the present invention, all other embodiments obtained by a person skilled in the art without creative labor fall within the scope of protection of the present invention.

It should be noted that, without conflict, the embodiments in the present invention and the features in the embodiments may be combined with each other.

The present invention is further described below in conjunction with the accompanying drawings and specific embodiments, but is not used as a limitation of the present invention.

In a preferred embodiment of the invention, based on the above-mentioned problems existing in the prior art, a charger with integrated engine start function is provided and is connected between an input terminal group and an output terminal group; wherein the input terminal group comprises a live wire L and a neutral wire N to connect to a power supply; the power supply is an AC power supply;

the output terminal group includes the first output terminal (Bat+) and the second output terminal (Bat−), which correspond to the positive pole and negative pole of the battery, respectively, to realize the electrical connection between the charger and the external battery.

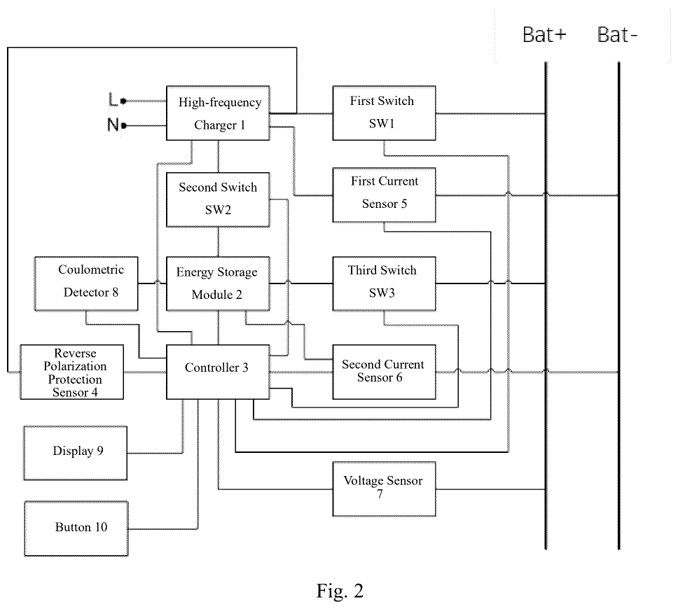

As shown in FIG. 2, the charger comprises:
a high-frequency charger 1, an input end of the high-frequency charger 1 is connected to a live wire L and a neutral wire N of the input terminal group,
an energy storage module 2,
a first switch SW1, controllably connected to a first output end of the high-frequency charger 1 and a first output terminal of the output terminal group;
a second switch SW2, controllably connected to a second output end of the high-frequency charger 1 and an input end of the energy storage module 2;
a third switch SW3, controllably connected to an output end of the energy storage module 2 and a first output terminal of the output terminal group;
a controller 3, a first output end of the controller 3 is connected to the first switch SW1, a second output end of the controller 3 is connected to the second switch SW2, and a third output end of the controller 3 is connected to the third switch SW3.

Specifically, considering the existing power frequency charger and high-frequency charger generally have the following defects in the design with engine starting function: the charging current cannot be continuously stabilized, the charging efficiency is low, the starting current is small, the equipment is bulky and not easy to carry, the AC power supply must be connected to start, the heat generation is large in the process of use, and these factors greatly restrict the performance and user experience of the product.

In the embodiment, the charger with integrated engine start function mainly comprises the following key components: the high-frequency charger 1, the energy storage module 2, three switches (the first switch SW1, the second switch SW2, the third switch SW3), and the controller 3, etc.

As the main electric energy conversion device, the high-frequency charger 1 carries out efficient conversion through the AC power supply connected to the power grid, to provide stable charging current for the battery. The high-frequency charger 1 is equipped with two input ends for connecting the input terminal group (live wire L and neutral wire N), and is provided with three output ends, one of the output ends is connected to the first output terminal (Bat+) of the output terminal group through the first switch SW1, the other of the output ends is connected with the energy storage module 2 through the second switch SW2, and the remaining output end is connected to the second output terminal (Bat−) of the output terminal group. In addition, the high-frequency charger is able to meet CEC or DOE efficiency regulations due to its high efficiency.

The energy storage module 2 is a component that stores electrical energy and provides instantaneous high-intensity current to start the engine when needed (e.g., an external battery fails).

The controller 3 plays a core control role in the whole charger, and its first output end, the second output end and the third output end are connected to the first switch SW1, the second switch SW2 and the third switch SW3 respectively. According to the charger operating state and user demand, the controller 3, by controlling the opened and closed state of these three switches, flexibly switches the connections between the high-frequency charger 1 and the output terminal group, between the high-frequency charger 1 and the energy storage module 2, and between the energy storage module 2 and the output terminal group, ensures the stable and efficient charging process and the high current supply when the engine starts.

In a preferred embodiment, wherein when the first switch SW1 is closed, the high-frequency charger 1 provides the output terminal group with a charging current or a starting current; and/or when the second switch SW2 is closed, the high-frequency charger provides the energy storage module 2 with the charging current; and/or when the third switch SW3 is closed, the energy storage module 2 provides the output terminal group with the starting current.

Specifically, the first switch SW1 is used to control the connection between the high-frequency charger 1 and the output terminal group. When the first switch SW1 is closed, the high-frequency charger 1 directly provides the battery with continuous and stable charging current by efficiently converting the input AC power.

The second switch SW2 is used to control the connection between the high-frequency charger 1 and the energy storage module 2. When the power of the energy storage module 2 is insufficient, the second switch SW2 is controlled to be closed, and the high-frequency charger 1 charges the energy storage module 2 to reserve sufficient energy, so that the energy storage module 2 can provide sufficient engine start current for the battery regardless of whether the high-frequency charger is connected to the input AC power supply in the future.

The third switch SW3 is used for controlling the connection between the energy storage module 2 and the output terminal group. When the third switch SW3 is closed, the energy storage module 2 provides the external battery with the high current required for start-up. Preferably, when the input end of the high-frequency charger 1 is connected to the AC power supply, the high-frequency charger 1 can also provide a starting current for the external battery at the same time with the energy storage module 2. As an example rather than a limitation, assuming that the energy storage module 2 provides 300 A current and the high-frequency charger 1 provides 20 A current, the energy storage module 2 and the high-frequency charger 1 provide 320 A current at the same time, which can further improve the starting efficiency. It should be noted that this is only an illustrative example and is not a specific limitation on the actual power supply capacity of the energy storage module 2 and the high-frequency charger 1. In fact, the current output of both can be flexibly configured and adjusted according to the actual application scenario and needs.

Furthermore, when the external battery fails, that is, the battery cannot provide enough instantaneous high current for the engine to start for some reason, the third switch SW3 is closed, and the path between the energy storage module 2 and the output terminal group is established. The energy storage module 2 quickly replaces the battery to provide the current required for the automobile engine to start. As a result, even if there is a problem with the battery or the power is insufficient, the automobile can still be forced to start the engine through the charger with integrated engine start function, which greatly improves the product's practicality and emergency response capabilities. This design effectively overcomes the problem of traditional chargers not being able to start the engine when the external battery fails, while also optimizing the overall performance of the charger and improving the user experience.

In a preferred embodiment, wherein further comprising:
a reverse polarization protection sensor 4, connected between a first output end of the high-frequency charger 1 and a first input end of the controller 3.

Specifically, in order to ensure the safety and reliability of the device and prevent the charger damage or safety accident caused by the reverse polarity of the battery, in the present embodiment, the reverse polarization protection sensor 4 is arranged to detect whether the battery polarity connection is correct, and the device damage caused by the reverse polarity of the battery is prevented.

Furthermore, the input end of the reverse polarization protection sensor 4 is electrically connected to the connection of the high-frequency charger 1 and the first switch SW1, and the output end of the reverse polarization protection sensor 4 is connected to the first input end of the controller 3, so that the polarity of connection of the output terminal group and the battery is monitored in real time. The specific monitoring principle is as follows: when the user connects the charger with the battery, the reverse polarization protection sensor 4 can detect the connection state of the output terminal group and the positive pole and negative pole of the battery at first. If the battery polarity is detected to be reversed, that is, the Bat+ terminal is connected to the negative pole of the battery, or the Bat-terminal is connected to the positive pole of the battery, the reverse polarization protection sensor 4 can send an alarm signal to the controller 3 immediately, and prevents the high-frequency charger 1 from outputting current to the battery, thereby effectively preventing the device damage or potential safety hazard caused by the reverse polarity of the battery.

Furthermore, after the controller 3 receives the alarm signal of the reverse polarization protection sensor 4, it can display the error message by the display screen, and notify the user to correct the battery polarity connection error in time, ensure the safety and normal progress of the charging process.

In a preferred embodiment, wherein further comprising:
a first current sensor 5, connected between the high-frequency charger 1 and a second output terminal of the output terminal group;
a second input end of the controller 3, connected to the first current sensor 5.

Specifically, in the embodiment, a first current sensor 5 is arranged on the connection line between the high-frequency charger 1 and the second output terminal (Bat−) of the output terminal group, to detect the charging current output from the high-frequency charger 1 to the battery in real time; simultaneously, the detected current data is transmitted to the controller 3, and the controller 3 controls the opened and closed state of the first switch SW1 according to the actual current size and the battery charging state, and effectively prevents the occurrence of undesirable phenomena such as overcharge and undercharge.

Furthermore, the controller 3 can also judge the state of the battery based on the current data, so that the energy storage module 2 can be activated when necessary to provide instantaneous high current for engine starting.

In a preferred embodiment, wherein further comprising:
a second current sensor 6, connected between the energy storage module 2 and a second output terminal of the output terminal group;
a third input end of the controller 3, connected to the second current sensor 6.

Specifically, in the embodiment, a second current sensor 6 is arranged on the connecting line between the energy storage module 2 and the second output terminal (Bat−) of the output terminal group, to monitor and record the current flowing from the energy storage module 2 to the battery in real time; simultaneously, the detected current data is fed back to the controller 3, and the controller 3 opens or closes the third switch SW3 according to the actual starting current size and the battery charging state, which effectively prevents the occurrence of undesirable phenomena such as overcharge and undercharge. In addition, in the event of an external battery failure, it ensures that the energy storage module 2 can safely and efficiently provide the high current required for start-up, thereby improving the overall performance of the charger.

In a preferred embodiment, wherein further comprising:
a voltage sensor 7, connected between a fourth input end of the controller 3 and the first output terminal of the output terminal group.

Specifically, in the embodiment, a voltage sensor 7 is arranged between the fourth input terminal of the controller 3 and the first output terminal (Bat+), to detect the voltage data of two ends of the battery in real time, and the detected voltage data is fed back to the controller 3.

Furthermore, the controller 3, according to the real-time voltage information that voltage sensor 7 feedbacks, can understand the charging state of battery, such as whether battery voltage reaches preset charging threshold, whether it has been fully charged, whether there is overvoltage or undervoltage and the like, then the controller 3 can adjust the operation mode of charger according to the charging state of battery, controls the closing and opening of the first switch SW1, the second switch SW2 and the third switch SW3, realizes the precise control of charging process and engine starting process, thereby effectively avoids the safety issues caused by overcharging, undercharging, or abnormal voltages, further optimizes the performance and user experience of the product.

In a preferred embodiment, wherein further comprising:
a coulometric detector 8, connected between the energy storage module 2 and a fifth input end of the controller 3.

Specifically, in the embodiment, a coulometric detector 8 is arranged between the energy storage module 2 and the fifth input end of the controller 3, the remaining power information of the energy storage module 2 is monitored in real time, and the real-time power data is fed back to the controller 3. Furthermore, after receiving the power data fed back by the coulometric detector 8, the controller 3 will control the closing and opening of the second switch SW2 according to the remaining power of the energy storage module 2.

When the power of the energy storage module 2 is insufficient, the controller 3 controls the second switch SW2 to close, and charges the energy storage module 2 through the high-frequency charger 1 in advance; or prompts the user the current power status of the energy storage module through the display screen, so as to ensure that the necessary energy support can be provided for engine start when needed, so as to improve the overall performance of the charger and the user's experience.

When the energy storage module 2 has sufficient power, the energy storage module 2 can provide sufficient engine starting current for the battery regardless of whether the high-frequency charger 1 is connected to the input AC power supply or not.

Furthermore, the power supply ends of the controller 3 are connected to a high-frequency charger 1 and an energy storage module 2 respectively. When the input end of the high-frequency charger 1 is connected to the AC power supply, the controller 3 is supplied with power by the high-frequency charger 1 or other AC/DC auxiliary power supply, so that the normal operation and function execution of the controller 3 are realized. When the input end of the high-frequency charger 1 is not connected to the AC power supply, the energy storage module 2 supplies power to the controller 3, so that the normal operation and function execution of the controller 3 are realized, which guarantees that the engine can still be started in the environment without the AC power supply, significantly expands the application scenario of the product, improves the convenience of use.

In a preferred embodiment, wherein further comprising: a display 9, electrically connected to the controller 3.

Specifically, in the embodiment, the display screen 9 provides users with an intuitive interactive interface, the display screen 9 realizes data exchange with the controller 3 through an electrical connection, and the controller 3 collects various parameters in the operating process of the charger in real time, and converts them into visual information and presents it on the display screen.

Furthermore, the display 9 can clearly display various relevant information, such as battery voltage, charging current, the remaining power of energy storage module 2, current operation mode, opening or closing status of the switch, and other data.

In the embodiment, there are at least three modes of operation of the charger, comprising a charging mode, a start mode, and a forced start mode.

When the user selects the charging mode, under the charging mode, the charger will, at first, detect the connection status of the battery, and if the battery polarity connection error is detected, it will remind the reverse connection state at present through the display. When the battery is properly connected, the charger will control the opening or closing state of the first switch SW1 according to the battery status for intelligent charging. The charging process follows the classic three-stage charging method, i.e., the constant current charging stage, the constant voltage charging stage, and finally the floating charging stage. During the constant current charging phase, the charger will stabilize the current at the battery's nominal rated current, to ensure that the battery receives charging evenly and safely.

Furthermore, the user can select the battery corresponding to the charging current size and the battery type according to the actual demand, and the battery refers to the battery between Bat+ and Bat−, and the selected battery is connected to the charger of the invention.

When the user selects the start mode, the controller in the charger (such as the microcontroller MCU) monitors the power of the energy storage module 2 in real time. As soon as the power of the energy storage module 2 rises up to a threshold sufficient to start the automobile's engine, the charger will automatically enter into the start-ready state. At this time, the user only needs to select the start through the button or the option on the display, and can use the instantaneous high current provided by the energy storage module 2 to start the automobile engine by controlling the opening or closing state of the third switch SW3, to assist or replace the battery to complete the engine starting process.

Furthermore, the starting current is usually in the range of 200 A to 1000 A, depending on the capacity of the energy storage module 2. The starting process is usually completed in as little as 2 to 3 seconds.

In special cases, when the battery voltage is too low for the charger to effectively recognize the battery connection status, the user can select the forced start mode. Before entering this mode, be confirmed that the battery is properly connected to prevent safety risks due to incorrect battery connection. On the premise of ensuring that the battery is connected correctly, even if the battery voltage is extremely low, the charger can try to provide, by controlling the opening or closing state of the third switch SW3, starting current through the energy storage module 2 to start the car engine, so as to solve the starting demand under extreme conditions (the battery is extremely low and the battery voltage is too low to start the engine normally) and avoid causing damage to the battery or the charger itself.

In a preferred embodiment, wherein further comprising: a button 10, electrically connected to the controller 3.

Specifically, in the embodiment, a user is provided with an intuitive operation mode through a button to realize a human-computer interaction function. The user can perform various operations on the charger through the buttons, such as selecting different operating modes (such as charging mode, start mode, forced start mode, etc.). The button 10 also communicates with controller 3 by electrical connection, and after the user presses button, the controller 3 can receive corresponding command signal, and adjust the working state of charger or display corresponding information according to the content of the command signal.

In a preferred embodiment, wherein the energy storage module 2 is one selected from the group comprising a supercapacitor module 201, a lithium battery 202, a lead-acid battery 203, and a combination thereof.

Specifically, in the embodiment, the energy storage module 2 is designed to adopt a plurality of types of electric energy storage elements, and the energy storage module 2 may be composed of a supercapacitor module 201, and/or a lithium battery 202, and/or a lead-acid battery 203, generating a large current energy in a short time and providing a large current sufficient for engine starting.

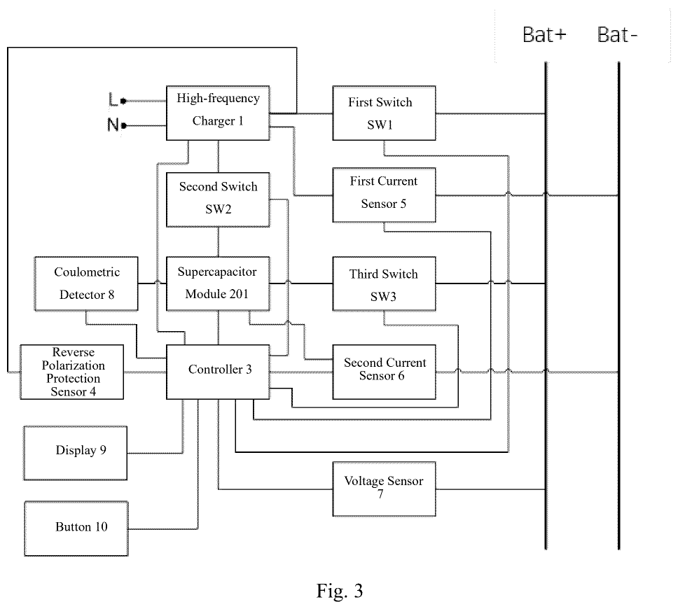

When the energy storage module 2 adopts the supercapacitor module 201, as shown in FIG. 3, the fast charging and discharging characteristics of the supercapacitor are used to quickly provide the peak current when the battery cannot provide sufficient starting current, so as to ensure the smooth start of the automobile engine.

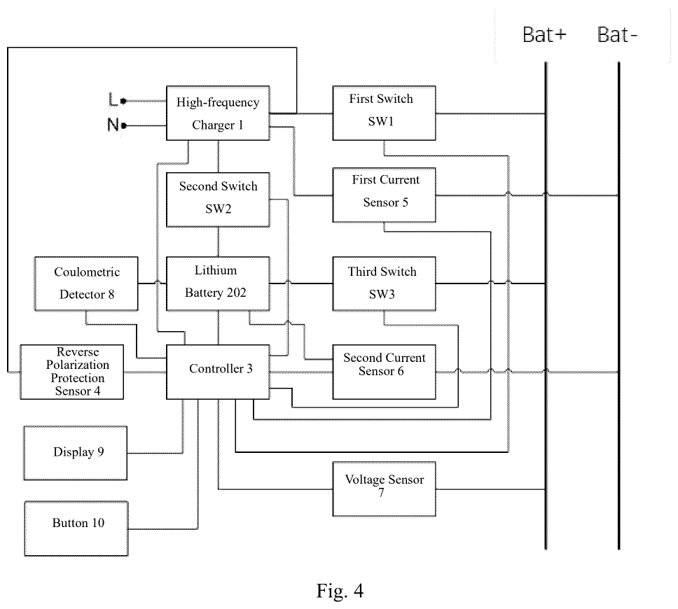

When lithium battery 202 is selected for energy storage module 2, as shown in FIG. 4, because lithium battery has high energy density and stable discharge characteristics, it can provide auxiliary charging for a long period of time when the power of the battery is insufficient, and can also provide stable starting current when the external battery fails.

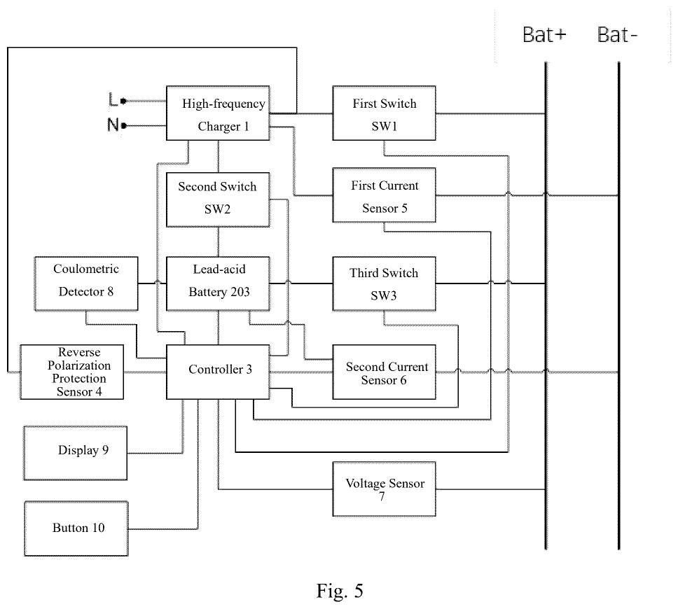

When the lead-acid battery 203 is used as the energy storage module 2, as shown in FIG. 5, the relatively low cost and mature and stable characteristics of the lead-acid battery 203 can also be used as a backup power source to provide the current required for engine start-up when necessary.

In practical applications, the energy storage module 2 can, according to the specific situation, flexibly combine supercapacitor module 201, lithium battery 202 and/or lead-acid battery 203 by means of series and parallel connection, to achieve the best performance matching and cost-effectiveness. The controller 3 will, according to the actual type and combination of the energy storage module 2, ensure the effective interaction between the energy storage module 2 and the high-frequency charger 1 and the output terminal group (Bat+ and Bat−) by precisely controlling the first switch SW2, the second switch SW3 and other related circuits, so as to provide safe and efficient charging and starting services.

The charger with integrated engine start function of the invention is usually a starter battery which is connected to the automobile, that is, the lead-acid battery or lithium battery of 12 volts or 24 volts that is often said, and these batteries are mainly responsible for providing instantaneous large current when automobile engine starts. When the battery power of automobile is insufficient, a charging current is transmitted to the battery through the high-frequency charger or energy storage module of the charger of the inventor. When the battery of the automobile cannot start the engine normally for some reason, the energy storage module of the charger of the utility model provides additional starting current to help the engine start.

In a preferred embodiment, the control method of the charger applying the above-mentioned integrated engine start function, the charger with the integrated engine start function comprises at least three operating modes:

At least one of the three operating modes is a start mode, and in the start mode, the third switch SW3 is closed, and the energy storage module 2 is configured to provide a starting current to the output terminal group during the start mode, or the first switch SW1 and the third switch SW3 are closed, and the high-frequency charger 1 and the energy storage module 2 are configured to simultaneously provide the output terminal group with a starting current during the start mode.

At least one of the three operating modes is a charging mode, and in the charging mode, the first switch SW1 is closed, and the high-frequency charger 1 is configured to provide the battery connected between the output terminal groups with the charging current during the charging mode.

At least one of the three operating modes is a forced start mode, and in the forced start mode, the third switch SW3 is closed, and the energy storage module 2 is configured to provide the output terminal group with a starting current during the forced start mode.

Furthermore, in the start mode, according to one or more monitoring parameters, the second switch SW2 is closed and the high-frequency charger 1 is configured to charge the energy storage module 2 during the preparation period for entering start mode until the preset conditions are reached.

Specifically, one or more monitoring parameters comprises power of the energy storage module 2.

Specifically, one or more monitoring parameters comprises battery status of the energy storage module 2.

Specifically, the preset conditions are the power of the energy storage module 2 rises up to a threshold sufficient to start the engine.

The advantages or beneficial effects of the above-mentioned technical scheme are as follows:
(1) Integrated starting function: the charger of the invention, by combining a high-frequency charger and an energy storage module, makes both two work together to provide a continuous and stable charging current for the battery, and can provide a strong instantaneous current sufficient to start the engine by the energy storage module when the external battery fails, and the functionality of the product has been greatly improved.
(2) Efficient and stable charging performance: thanks to the application of high-frequency charger, the charger of the invention realizes the continuous stability of charging current, improves charging efficiency, shortens charging time, and reduces the energy loss of battery in charging process.
(3) Strong starting ability: the existence of energy storage module makes the charger of the invention can provide high-current start at critical moment, ensures that the engine can also start smoothly when the battery state is not good, greatly enhances the emergency handling ability of the product and use reliability of the product.
(4) Lightweight, portable and flexible application: compared with the traditional charger that uses the large-volume linear battery charger, the volume of the above-mentioned high-frequency charger and the energy storage module occupies a small area, so that the charger of the invention is designed to be compact, light in weight, easy to carry, and in the environment of no AC power supply, it can still start the engine, significantly expands the application scenario of the product, improves the convenience of use.
(5) Low heat generation and high safety: during the use, due to the high-performance high-frequency charging technology, the charger of the invention has low calorific value, not only prolongs the service life of the device, but also ensures the safety of the user in the operation process, improves the user experience.

The above is only a preferred embodiment of the present invention, and does not intend to limit the embodiment and scope of protection of the present invention, and those skilled in the art should be able to realize that all solutions obtained by equivalent substitutions and obvious changes made by using the contents of the description and illustrations shall be included in the scope of protection of the present invention.

1. A charger with integrated engine start function, which is connected between an input terminal group and an output terminal group, comprising:
a high-frequency charger, an input end of the high-frequency charger being connected to the input terminal group,
an energy storage module,
a first switch, controllably connected to a first output end of the high-frequency charger and a first output terminal of the output terminal group;
a second switch, controllably connected to a second output end of the high-frequency charger and an input end of the energy storage module;
a third switch, controllably connected to an output end of the energy storage module and a first output terminal of the output terminal group;
a controller, a first output end of the controller being connected to the first switch, a second output end of the controller being connected to the second switch, and a third output end of the controller being connected to the third switch.

2. The charger with integrated engine start function of claim 1, further comprising:
a reverse polarization protection sensor, connected between a first output end of the high-frequency charger and a first input end of the controller.

3. The charger with integrated engine start function of claim 1, further comprising:
a first current sensor, connected between the high-frequency charger and a second output terminal of the output terminal group;
a second input end of the controller, connected to the first current sensor.

4. The charger with integrated engine start function of claim 1, further comprising:
a second current sensor, connected between the energy storage module and a second output terminal of the output terminal group;
a third input end of the controller, connected to the second current sensor.

5. The charger with integrated engine start function of claim 1, further comprising:
a voltage sensor, connected between a fourth input end of the controller and the first output terminal of the output terminal group.

6. The charger with integrated engine start function of claim 1, further comprising:
a coulometric detector, connected between the energy storage module and a fifth input end of the controller.

7. The charger with integrated engine start function of claim 1, further comprising: a display and a button, electrically connected to the controller.

8. The charger with integrated engine start function of claim 1, wherein the energy storage module is one selected from the group comprising a supercapacitor module, a lithium battery, a lead-acid battery, and a combination thereof.

9. The charger with integrated engine start function of claim 1, wherein when the first switch is closed, the high-frequency charger provides the output terminal group with a charging current or a starting current; and/or
when the second switch is closed, the high-frequency charger provides the energy storage module with the charging current; and/or
when the third switch is closed, the energy storage module provides the output terminal group with the starting current.
